(19) United States
(12) Patent Application Publication
(10) Pub. No.: US 2010/0323275 A1
(43) Pub. Date: Dec. 23, 2010

(54) ION CONDUCTIVE COMPOSITION, ION CONDUCTIVE FILM CONTAINING THE SAME, ELECTRODE CATALYST MATERIAL, AND FUEL CELL

(75) Inventors: Yoichiro Machida, Ibaraki (JP); Katsuhiko Iwasaki, Ibaraki (JP); Toshihiko Tanaka, Ibaraki (JP); Takashi Hibino, Aichi (JP); Ken Yoshimura, Ibaraki (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Chuo-ku (JP)

(21) Appl. No.: 12/525,926

(22) PCT Filed: Feb. 5, 2008
(86) PCT No.: PCT/JP2008/051846

§ 371 Date: Sep. 29, 2009

(30) Foreign Application Priority Data
Feb. 8, 2007 (JP) 2007-028979

(51) Int. Cl. H01M 8/10

(52) U.S. Cl. 429/493; 429/479; 429/492

(57) ABSTRACT

An object of the present invention is to provide an ion-conductive composition that has proton conductivity over a wide temperature range, including the intermediate and high temperature range of 100° C. and higher, and an ion-conductive composite material such as ion-conductive membrane prepared from the composition. The composite ion-conductive material comprises the ion-conductive composition of the present invention, and the ion-conductive composition includes an ion-conductive polymer and ion-conductive inorganic solid material.

### TECHNICAL FIELD

The present invention relates to an ion-conductive composition used for instance in fuel cells, and an ion-conductive membrane, an electrode catalyst material, and a fuel cell, containing the same.

### BACKGROUND ART

Ion-conductive materials are used as electrolytes in fuel cells, lithium ion batteries, etc. There are great expectations from fuel cells, particularly as a next generation substitute for internal combustion engines. In automobiles in particular, fuel cells are an important technology that could also, at one stroke, solve the exhaust gas-related problems of gasoline engines and diesel engines. In recent years, ion-conductive materials comprising ion-conductive polymers have been studied as electrolytes (proton conductors) of fuel cells. These ion-conductive polymers can be used even at relatively low temperatures. However, as they show almost no proton conductivity unless they are in a hydrated state, they have the shortcoming of having almost no ionic conductivity in the intermediate and high temperature range above 100° C., which limited their use to low temperatures of not more than 100° C. in most cases. For example, Patent Document 1 mentions that aromatic polyether sulfone block copolymers having a block containing sulfonic acid group and a block containing no sulfonic acid group at a specific weight ratio have proton conductivity that is not much affected by humidity or temperature. However, even in such copolymers, the proton conductivity showed a marked decline in the intermediate and high temperature range.

If ion-conductive materials can be used in the intermediate and high temperature range in fuel cells, this would provide the advantages of less poisoning of the catalyst layer by the carbon monoxide in the fuel gas, and effective utilization of the exhaust heat. However, almost all the ion-conductive materials disclosed so far do not have sufficient ionic conductivity in a practically wide enough temperature range because of the above problems with the ion-conductive polymers.
Patent Document 1: Japanese Patent Laid-Open No. 2003-31232 (Claims and Paragraph [0009])

### DISCLOSURE OF THE INVENTION

The object of the present invention is to provide an ion-conductive composition that shows proton conductivity over a wide temperature range, including the intermediate and high temperature range where it is difficult to use ion-conductive materials developed so far, and an ion-conductive composite material such as ion-conductive membrane prepared from the composition.

After painstaking investigations, the present inventors found an ion-conductive composition that can solve the above problems, and perfected the present invention. In short, the present invention provides the ion-conductive composition as in [1] described below:
[1] An ion-conductive composition comprising an ion-conductive polymer and an ion-conductive inorganic solid material.

The present invention further provides [2] to [18] listed below as suitable embodiments of ion-conductive compositions related to [1]
[2] The ion-conductive composition according to [1], wherein the content by weight of the ion-conductive inorganic solid material is higher than the content by weight of the ion-conductive polymer.
[3] The ion-conductive composition according to [1] or [2], wherein the ion-conductive inorganic solid material is a metal phosphate.
[4] The ion-conductive composition according to [3], wherein the metal phosphate is a phosphate having as the metal element one or more metal elements M selected from the group of elements in Group 4A and Group 4B of the long form of the periodic table, where M is partially substituted with a doping element J (wherein J is one or more elements selected from the group of elements in Group 3A and Group 3B of the long form of the periodic table).
[5] The ion-conductive composition according to [4], wherein the phosphate having the metal element M is a phosphate substantially represented by the following chemical formula (1):

MP₂O₇ (1)

(wherein M represents an element selected from the group of elements in Group 4A and Group 4B of the long form of the periodic table).
[6] The ion-conductive composition according to [4] or [5], wherein the metal phosphate is a metal phosphate that is substantially represented by the following chemical formula (2).

M₁₋ₓJₓP₂O₇ (2)

(In this formula, the value of x is in the range 0.001 to 0.3 both inclusive, and M and J have the same meaning as described above).
[7] The ion-conductive composition according to any of [4] to [6], wherein the metal phosphate comprises one or more elements selected from the group consisting of In, B, Al, Ga, Sc, Yb, and Y, as the doping element J.
[8] The ion-conductive composition according to any of [4] to [7], wherein the metal phosphate comprises Al as a doping element J.
[9] The ion-conductive composition according to any of [4] to [8], wherein the metal phosphate is a metal phosphate whose doping element J is Al.
[10] The ion-conductive composition according to any of [4] to [9], wherein the metal element M of the metal phosphate is one or more selected from the group consisting of Sn, Ti, Si, Ge, Pb, Zr, and Hf.
[11] The ion-conductive composition according to any of [4] to [10], wherein the metal element M of the metal phosphate is Sn.
[12] The ion-conductive composition according to any of [1] to [11], wherein the composition is prepared by grinding and mixing a powder form of the ion-conductive polymer and a powder form of the ion-conductive inorganic solid material.
[13] The ion-conductive composition according to any of [1] to [12], wherein the composition further comprises a fluorine resin.
[14] The ion-conductive composition according to [13], wherein the fluorine resin is polytetrafluoroethylene.
[15] The ion-conductive composition according to [13], wherein the fluorine resin is polyvinylidene fluoride.
[16] The ion-conductive composition according to any of [1] to [15], wherein the glass transition point temperature of the ion-conductive polymer is 90° C. or higher.
[17] The ion-conductive composition according to any of [1] to [16], wherein the ion-conductive polymer has an aromatic ring in the main chain thereof.
[18] The ion-conductive composition according to any of [1] to [17], wherein the ion-conductive polymer is a block copolymer having both a block having an ion exchange group and a block having substantially no ion exchange group.
[19] The ion-conductive composition according to [18], wherein the ion-conductive polymer is a block copolymer containing a block represented by the following chemical formula (3) as the block having an ion exchange group:

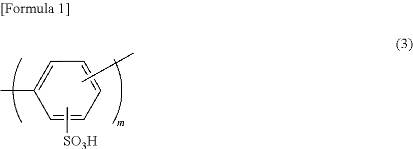

(wherein m is an integer 5 or more).
[20] The ion-conductive composition according to [18], wherein the ion exchange group in the ion-conductive polymer is a basic ion exchange group.
[21] The ion-conductive composition according to [20], wherein the ion exchange group in the ion-conductive polymer is a nitrogen atom-containing basic ion exchange group.
[22] The ion-conductive composition according to [20] or [21], wherein the composition comprises a metal phosphate as the ion-conductive inorganic solid material, and further comprises phosphoric acid.

The present invention further provides [23] to [26] listed below, wherein any of the above-described ion-conductive compositions is used.
[23] An ion-conductive membrane, prepared from an ion-conductive composition according to any of [1] to [22].
[24] An electrode catalyst composition comprising an ion-conductive composition according to any of [1] to [22], and a catalyst material.
[25] A membrane-electrode assembly comprising an ion-conductive membrane according to [23] and/or a catalyst layer prepared from an electrode catalyst composition according to [24].
[26] A fuel cell comprising the membrane-electrode assembly as in [25].

### Effect of the Invention

The ion-conductive composite materials made from the ion-conductive composition of the present invention can show ionic conductivity over a wide temperature range. In short, the invention enables the production of ion-conductive composite materials that show the excellent effect of having ionic conductivity in the intermediate and high temperature range where ion-conductive materials prepared from the ion-conductive polymers developed so far show almost no ionic conductivity. Besides this, fuel cells that use such composite material as electrolyte are very useful from the industrial point of view, because the amount of precious metal catalyst such as the platinum contained in the catalyst layer can be reduced.

### BRIEF DESCRIPTION OF THE DRAWINGS

FIG. 1 is a graph showing the proton conductivity (membrane thickness direction) at different temperatures in Example 1 and Comparative Example 1.

### BEST MODES FOR CARRYING OUT THE INVENTION

The preferred embodiments of the present invention are described below in detail.

The ion-conductive composition of the present invention contains at least one type of ion-conductive polymer and at least one type of ion-conductive inorganic solid material. Here, the “inorganic solid material” is defined as an inorganic substance that is in the solid state at normal temperature (about 25° C.). An ion-conductive ceramic is a preferred inorganic solid material. A material having high ionic conductivity, preferably proton conductivity, at intermediate and high temperatures, and is stable, is used as the ion-conductive ceramic. Any proton conductive ceramic known in the field may be suitably selected and used as such ceramics. Preferable examples include metal phosphate, yttrium-stabilized zirconia, and ceria ceramics. The present inventors found out that a metal phosphate was particularly suitable because of its higher proton conductivity at normal temperature.

Metal Phosphate

The present inventors discovered that metal phosphates are preferable among the above-described ion-conductive inorganic solid materials. Here, the metal phosphates are those that comprise a metal element and any one from among a phosphite ion, a phosphate ion and a polyphosphate ion, and have ionic conductivity, preferably proton conductivity.

The preferred metal phosphates will be described in greater detail. A preferable metal phosphate is a phosphate that has as the metal element one or more metal elements M selected from the group of elements in Group 4A and Group 4B of the long form of the periodic table, and M is partially substituted with a doping element J (wherein J is one or more elements selected from the group of elements in Group 3A and Group 3B of the long form of the periodic table).

Compounds like orthophosphates and pyrophosphates may be listed as examples of the above-described phosphates that induce the metal phosphate used in the present invention. Specific examples include tin phosphate, titanium phosphate, silicon phosphate, germanium phosphate, and zirconium phosphate.

Among the phosphates listed above as examples, pyrophosphate is preferably used. Such pyrophosphates are substantially represented by the following chemical formula (1).

MP₂O₇ (1)

(In this formula, M has the same meaning as described above).

The preferred metal phosphates induced from the phosphate of the above chemical formula (1) are substantially represented by the following chemical formula (2).

M₁₋ₓJₓP₂O₇ (2)

(In this formula, the value of x is in the range 0.001 to 0.3 both inclusive, and M and J have the same meaning as described above).

Here “substantially represented by chemical formula (2) ” means that in the compositional ratio of chemical formula (2), i.e., the M:J:P (phosphorus atom): O (oxygen atom) molar ratio [(1-x):x:2:7], the proportion of each of the P and O components can be increased or decreased slightly from the respective values of 2 and 7 to an extent that does not inhibit the ion conductivity. Here “slightly” usually means within about 10%, although this depends on the type of the M or J used. This percentage is preferably small.

In the chemical formula (2), x corresponds to the substitution ratio of M by the dopant element J, and its value is in the range 0.001 to 0.3 both inclusive, preferably 0.02 to 0.2 both inclusive, although this depends on the type of M. When M is Sn (tin atom) and J is Al (aluminum atom), the preferable range of x for achieving high proton conductivity is 0.01 to 0.1 both inclusive, more preferably 0.02 to 0.08 both inclusive, and even more preferably 0.03 to 0.07 both inclusive.

The metal element M in the phosphate represented by chemical formula (1) and in the metal phosphate represented by chemical formula (2) is one or more elements selected from the group of elements in Group 4A and Group 4B of the long form of the periodic table. For example, one or more elements selected from among the group consisting of Sn (tin atom), Ti (titanium atom), Si (silicon atom), Ge (germanium atom), Pb (lead atom), Zr (zirconium atom), and Hf (hafnium atom) are preferably used. Considering the stability of the metal phosphate itself, and for obtaining a high level of proton conductivity, it is preferable to use, as M, one or more metal elements selected from the group consisting of Sn, Ti, and Zr, the more preferable being Sn and/or Ti, Sn being particularly preferable.

The doping element J is one or more elements selected from the group of elements in Group 3A and Group 3B of the long form of the periodic table, and it is preferable that it contains at least one element selected from among In (indium atom), B (boron atom), Al (aluminum atom), Ga (gallium atom), Sc (scandium atom), Yb (ytterbium atom), and Y (yttrium atom). The more preferable doping element J is one or more elements selected from among In, Al, Ga, Sc, and Yb, although it may be optimized according to the type of the M used. Considering the stability of the metal phosphate, and for obtaining a high level of proton conductivity, it is preferable to use, as J, Al and/or Ga, particularly Al, when M contains Sn.

Any known method can be suitably selected and used as the method of preparing the metal phosphate wherein the metal element

M is partly substituted with the doping element J as described above. One example is to prepare the metal phosphate using as starting materials a compound containing M, a compound containing J, and a phosphorus compound, through a process that includes the following steps (a) and (b) in that order.
(a) A step wherein the compound containing M, a hydroxide of J, and phosphoric acid are allowed to react to obtain a reaction product.
(b) A step wherein the reaction product obtained in (a) is heat-treated.

The compound containing M may be suitably selected according to the type of M. However, it is preferable to use an oxide or a compound, such as hydroxide, carbonate, nitrate, halide, or oxalate that forms an oxide when decomposed at high temperature or oxidized at high temperature. For example, when using Sn as M, any of various tin oxides and/or their hydrates, preferably tin dioxide or its hydrate, can be used.

Phosphoric acid, phosphonic acid, etc may be listed as examples of phosphorus compounds, and phosporic acid is preferable, considering its reactivity. Usually, a concentrated aqueous solution of phosphoric acid containing 50 wt. % or more of the acid may be used as the phosphoric acid, and it is preferable to use a concentrated aqueous solution of phosphoric acid containing 80 to 90 wt. % of the acid, considering the ease in handling.

In step (a), the reaction temperature can be suitably selected according to the composition of the metal phosphate to be synthesized but usually it is preferable to carry out the reaction in the temperature range 200 to 400° C. For example, for synthesizing a compound containing Sn, it is preferable to carry out the reaction in the temperature range 250 to 350° C., more preferably 270 to 330° C. Also, it is better to thoroughly mix the reaction mixture during the reaction, by stirring. For ease in handling of the reaction product obtained, in some cases, it would be effective to add a suitable amount of water during the reaction to maintain appropriate viscosity of the reaction product and to prevent its solidification. The reaction time may be suitably selected, depending on the composition of the metal phosphate to be synthesized. However, it is preferable to take as long a time as possible. Nevertheless, considering the productivity, a reaction time in the range of 1 to 20 hours is preferable. The reaction product obtained in Step (a) in this manner is usually in the form of a paste.

Next, the metal phosphate is obtained in Step (b) by heat-treating the reaction product obtained in Step (a). When a compound containing Sn is used as described above, the heat treatment is preferably done in the temperature range 500 to 800° C., more preferably in the range 600 to 700° C., and even more preferably in the range 630 to 680° C. The time required for heat treatment is usually in the range of 1 to 20 hours, preferably 1 to 5 hours, and more preferably 2 to 5 hours.

Ion-Conductive Polymer

Next, the ion-conductive polymer used in the present invention will be described.

Any ion-conductive polymer known in the concerned field may be suitably selected as the ion-conductive polymer. However, it is preferable to use a polymer, which is comparatively stable even in the intermediate and high temperature range (100 to 300° C.). Also, it is preferable that the material undergoes not much softening at intermediate and high temperature, as deformation also causes problems. To be more specific, it is preferable to use an ion-conductive polymer with a glass transition point temperature (Tg) of 90° C. or higher, preferably 120° C. or higher, and even more preferably 150° C. or higher, 180° C. or higher being particularly preferable. Mixtures of two or more ion-conductive polymers may also be used.

Specific examples of the ion-conductive polymer include various perfluorosulfonic acid polymer and aromatic polymer electrolytes. Among these, sulfonated aromatic polymers are preferable because of their good stability in the intermediate and high temperature range. Specific examples include polymer electrolytes described in the literature, for instance in “Nenryo Denchi to Kobunshi, Kobunshi Sentan Zairyo One Point 7 (Fuel Cells and Polymers—Advanced Polymer Materials One Point 7 (in Japanese)”, Society of Polymer Science, Japan Ed., Kyoritsu Shuppan Co., Ltd., pp. 37-79 (2005)).

Ion-conductive polymers having strongly acidic groups are more preferable, and examples of such strongly acidic groups include sulfonic acid group (—SO₃H), sulfonamide group (—SO₂—NH₂), sulfonylimide group (—SO₂—NH—SO₂—), sulfuric acid group (—OSO₃H), a fluoroalkylene sulfonate group (for example, —CF₂SO₃H), and an oxocarbon group represented by the following chemical formula (7). The sulfonic acid group is particularly preferable.

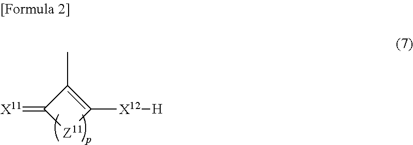

(In this formula, X¹¹ and X¹² each independently represents an oxygen atom, a sulfur atom, or a group represented by —NQ₁-; and Z¹¹ represents a carbonyl group, a thiocarbonyl group, a group represented by —C(NQ₂)—, an optionally substituted alkylene group, or an optionally substituted arylene group. Q₁ and Q₂ are hydrogen atoms, optionally substituted C1 to C6 alkyl groups, or optionally substituted C6 to C10 aryl groups. p represents the number of repeats and is an integer 0 to 10. When p is 2 or greater, the more than one Z¹¹ s can be the same or different).

The ion-conductive polymer preferred for use in the present invention is an ion-conductive polymer having a strongly acidic group, and usually, one having a proton conductivity of 1×10⁻⁴ S/cm or more, preferably about 1×10 to 1 S/cm, is used.

Specific examples of such ion-conductive polymers include:
(A) An ion-conductive polymer that has a main chain comprising an aliphatic hydrocarbon, and is in a form wherein a strongly acidic group is bonded to the main chain directly or through a suitable atom or group of atoms;
(B) An ion-conductive polymer that is a polymer comprising an aliphatic hydrocarbon, wherein the hydrogen atoms of the main chain are partly or wholly substituted with fluorine, and that is in a form wherein a strongly acidic group is bonded to the main chain directly or through a suitable atom or group of atoms;
(C) An ion-conductive polymer that has an aromatic ring in the main chain, and that is in a form wherein a strongly acidic group is bonded to the main chain directly or through a suitable atom or group of atoms;
(D) An ion-conductive polymer that is an inorganic polymer such as polysiloxane and polyphosphazene, wherein the main chain has substantially no carbon atoms, and that is in a form wherein a strongly acidic group is bonded to the main chain directly or through a suitable atom or group of atoms; and
(E) An ion-conductive polymer that is a copolymer comprising 2 or more types of repeating units selected from among the repeating units that constitute the polymers (A) to (D), before the introduction of the strongly acidic group, and that is in a form wherein a strongly acidic group is bonded to the copolymer directly or through a suitable atom or group of atoms.

Examples of the ion-conductive polymer (A) described above include polyvinyl sulfonic acid, polystyrene sulfonic acid, and poly(a-methylstyrene)sulfonic acid.

Examples of the ion-conductive polymer (B) described above include a sulfonic acid type polystyrene-graft-ethylene-tetrafluoroethylene copolymer (ETFE) comprising a main chain created by copolymerization of a fluorine carbide vinyl monomer and a hydrocarbon vinyl monomer, and hydrocarbon side chains having a sulfonic acid group (for example, Japanese Patent Laid-Open No. 09-102322), and a sulfonic acid type poly(trifluorostyrene)-graft-polytrifluoroethylene, which is prepared by graft polymerization of α,β,β-trifluorostyrene with a copolymer of fluorine carbide vinyl monomer and a hydrocarbon vinyl monomer and introduction of a sulfonic acid group therein (for example, U.S. Pat. No. 4,012,303 and U.S. Pat. No. 4,605,685).

The ion-conductive polymer (C) described above can have a heteroatom such as an oxygen atom in the main chain, and examples include homoplymers like polyether ether ketone, polysulfone, polyether sulfone, poly(arylene ether), polyimide, poly((4-phenoxybenzoyl)-1,4-phenylene), polyphenylene sulfide, and polyphenylquinoxaline, each having introduced sulfonic acid groups; and sulfoarylated polybenzimidazole and sulfoalkylated polybenzimidazole.

Examples of the ion-conductive polymer (D) described above include a resin wherein a sulfonic acid group is introduced into polyphosphazene.

The ion-conductive polymer (E) described above can be in the form of a random copolymer having a strongly acidic group introduced therein, an alternate copolymer having a strongly acidic group introduced therein, or a block copolymer having a strongly acidic group introduced therein. Examples of ion-conductive polymers having a sulfonic acid group as the strongly acidic group include polymers such as random copolymers having a sulfonic acid group introduced therein, such as the sulfonated polyethersulfone-dihydroxy biphenyl cocondensate disclosed in Japanese Patent Laid-Open No. 11-116679.

One of the preferable ion-conductive polymers for the present invention, considering the heat resistance, is an ion-conductive polymer having an aromatic ring in the main chain and a strongly acidic group, as described for (C) above. Specific examples of such an ion-conductive polymer include an ion-conductive polymer having a structural unit represented by the following chemical formula (8), and having the above-described strongly acidic group at least in some of the structural units. Sulfonic acid group is preferred as the strongly acidic group.

[Formula 3]

Ar¹¹—R¹¹ (8)

(In this formula, Ar¹¹ represents a divalent aromatic group optionally substituted with a C1 to C10 alkyl group, a C1 to C10 alkoxy group, a C6 to C10 aryl group, or a C6 to C10 aryloxy group; and R¹¹ represents a direct bond, an oxy group, a thioxy group, a carbonyl group, a sulfinyl group or a sulfonyl group).

Examples of groups represented by Ar¹¹ in the above chemical formula (8) include divalent monocyclic aromatic groups such as 1,3-phenylene and 1,4-phenylene; divalent condensed ring aromatic groups such as 1,3-naphthalenediyl, 1,4-naphthalenediyl, 1,5-naphthalenediyl, 1,6-naphthalenediyl, 1,7-naphthalenediyl, 2,6-naphthalenediyl, and 2,7-naphthalenediyl; divalent aromatic groups with more than one aromatic ring, such as 3,3′-biphenylylene, 3,4′-biphenylylene, 4,4′-biphenylylene, diphenylmethane-4′,4′-diyl, 2,2-diphenylpropane-4′,4″-diyl, and 1,1,1,3,3,3-hexafluoro-2,2-diphenylpropane-4′4″-diyl; and heterocyclic aromatic groups like pyridinediyl, quinoxalinediyl and thiophenediyl. Among these, divalent monocyclic aromatic groups are preferable.

Furthermore, these aromatic groups may be optionally substituted, as described earlier, with a C1 to C10 alkyl group, a C1 to C10 alkoxy group, a C6 to C10 aryl group, or a C6 to C10 aryloxy group. Here, examples of C1 to C10 alkyl groups include methyl group, ethyl group, n-propyl group, isopropyl group, n-butyl group, sec-butyl group, tert-butyl group, isobutyl group, n-pentyl group, 2,2-dimethylpropyl group, cyclopentyl group, n-hexyl group, cyclohexyl group, 2-methylpentyl group, and 2-ethylhexyl group; and these alkyl groups having substitution with a halogen atom like fluorine atom, chlorine atom, and bromine atom, a hydroxyl group, a nitrile group, an amino group, a methoxy group, an ethoxy group, an isopropyloxy group, a phenyl group, a phenoxy group, etc, and having a total of 1 to 10 carbon atoms, including those in the substituted groups.

Examples of C1 to C10 alkoxy groups include methoxy group, ethoxy group, n-propyloxy group, isopropyloxy group, n-butyloxy group, sec-butyloxy group, tert-butyloxy group, isobutyloxy group, n-pentyloxy group, 2,2-dimethylpropyloxy group, cyclopentyloxy group, n-hexyloxy group, cyclohexyloxy group, 2-methylpentyloxy group, and 2-ethylhexyloxy group; and these alkoxy groups having substitution with a halogen atom like fluorine atom, chlorine atom, and bromine atom, a hydroxyl group, a nitrile group, an amino group, a methoxy group, an ethoxy group, an isopropyloxy group, a phenyl group, a phenoxy group, etc, and having a total of 1 to 10 carbon atoms, including those in the substituted groups.

Examples of C6 to C10 aryl groups include phenyl group, and naphthyl group; and these aryl groups having substitution with a halogen atom like fluorine atom, chlorine atom, and bromine atom, a hydroxyl group, a nitrile group, an amino group, a methoxy group, an ethoxy group, an isopropyloxy group, a phenyl group, a phenoxy group, etc, and having a total of 6 to 10 carbon atoms, including those in the substituted groups.

Examples of C6 to C10 aryloxy groups include phenoxy group and naphthyloxy group; and these aryloxy groups having substitution with a halogen atom like fluorine atom, chlorine atom, and bromine atom, a hydroxyl group, a nitrile group, an amino group, a methoxy group, an ethoxy group, an isopropyloxy group, a phenyl group, a phenoxy group, etc, and having a total of 6 to 10 carbon atoms, including those in the substituted groups.

Examples of structural units having a sulfonic acid group introduced into the structural unit represented by the above chemical formula (8) include the structural units represented by the following 10-1 to 10-16.

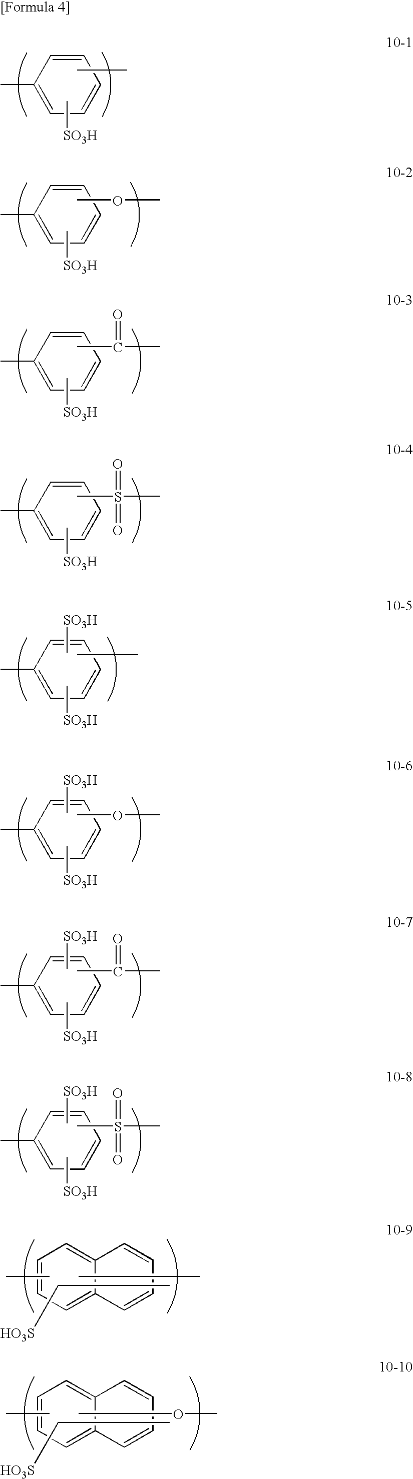

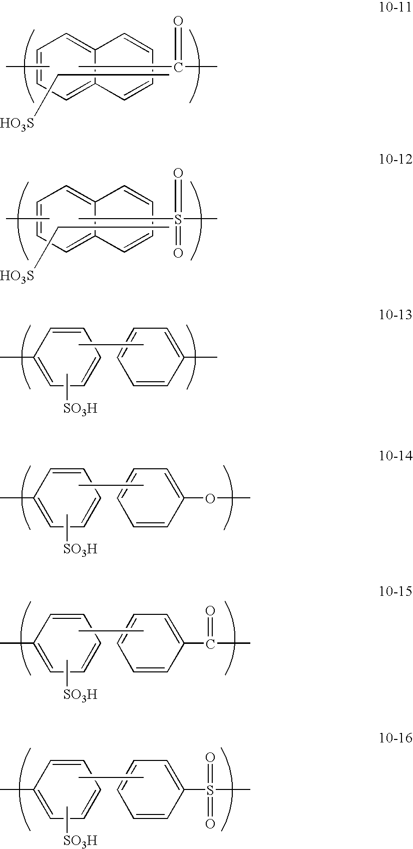

Among the structural units listed above, 10-1, 10-9, or 10-13 are preferable for obtaining polymer electrolytes with superior mechanical strength.

Furthermore, it is preferable if the polymer electrolyte having the structural unit represented by chemical formula (8) has, for instance, a structural unit represented by the following chemical formula (8a), (8b) or (8c).

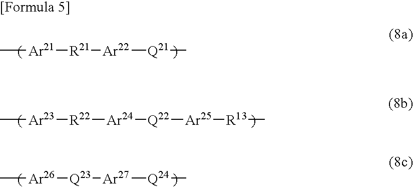

(In these formulas, Ar²¹, Ar²², Ar²³, Ar²⁴, Ar²⁵, Ar²⁶, and Ar²⁷ (hereinafter referred to as “Ar²¹ to Ar²⁷”) each independently represents a divalent aromatic group which may optionally have a C1 to C10 alkyl group, a C1 to C10 alkoxy group, a C6 to C10 aryl group, or a C6 to C10 aryloxy group; Q²¹ to Q²⁵ each independently represents an oxy group or a thioxy group; and R²¹, R²², and R²³ each independently represents a carbonyl group or a sulfonyl group).

In the above chemical formulas (8a), (8b) and (8c), the same groups as listed as examples for the above-described Ar¹¹ can be examples of the groups represented by Ar²¹ to Ar²⁷.

Examples of structural units wherein a sulfonic acid group is introduced into a structural units represented by the above chemical formula (8a), include the structural units represented by the following 11-1 to 11-7.

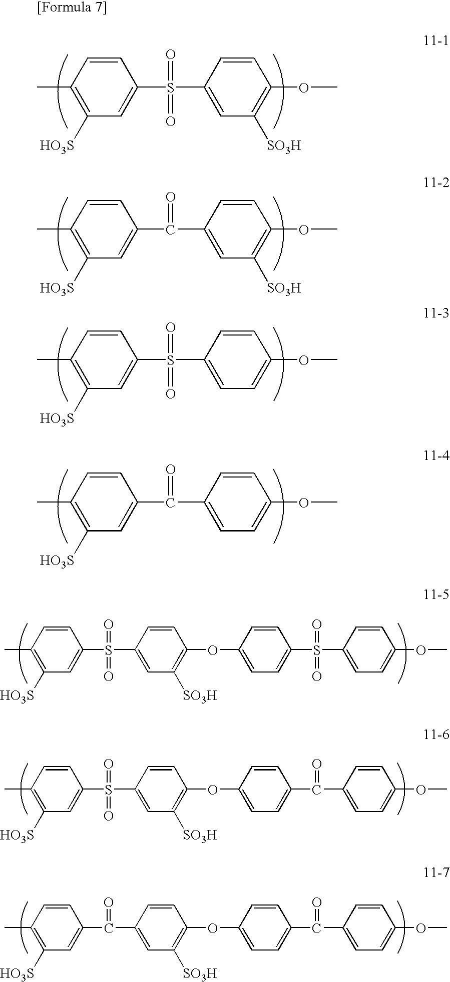

Examples of a structural unit represented by the above chemical formula (8b), include the structural units represented by the following 12-1 to 12-15.

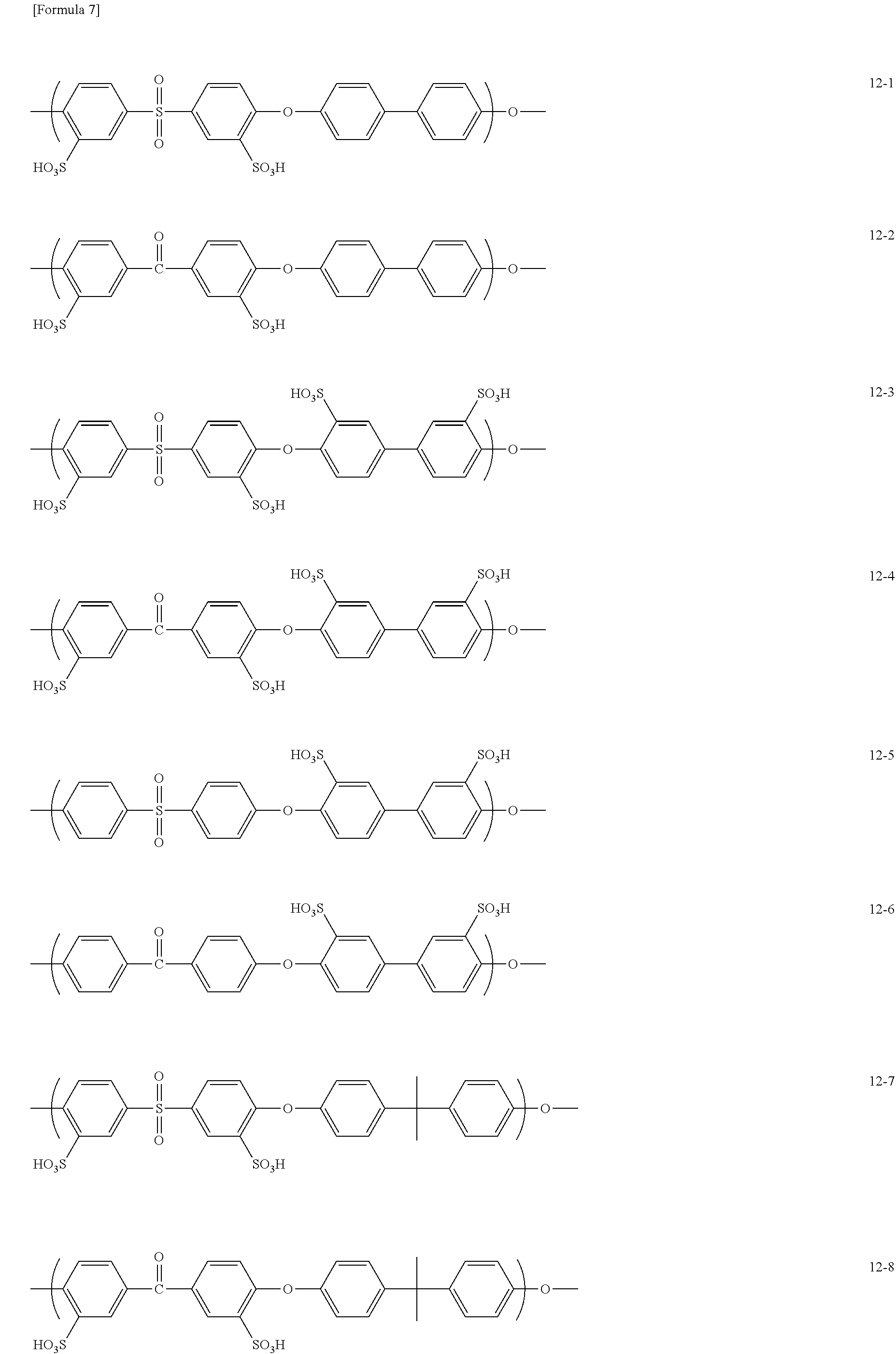

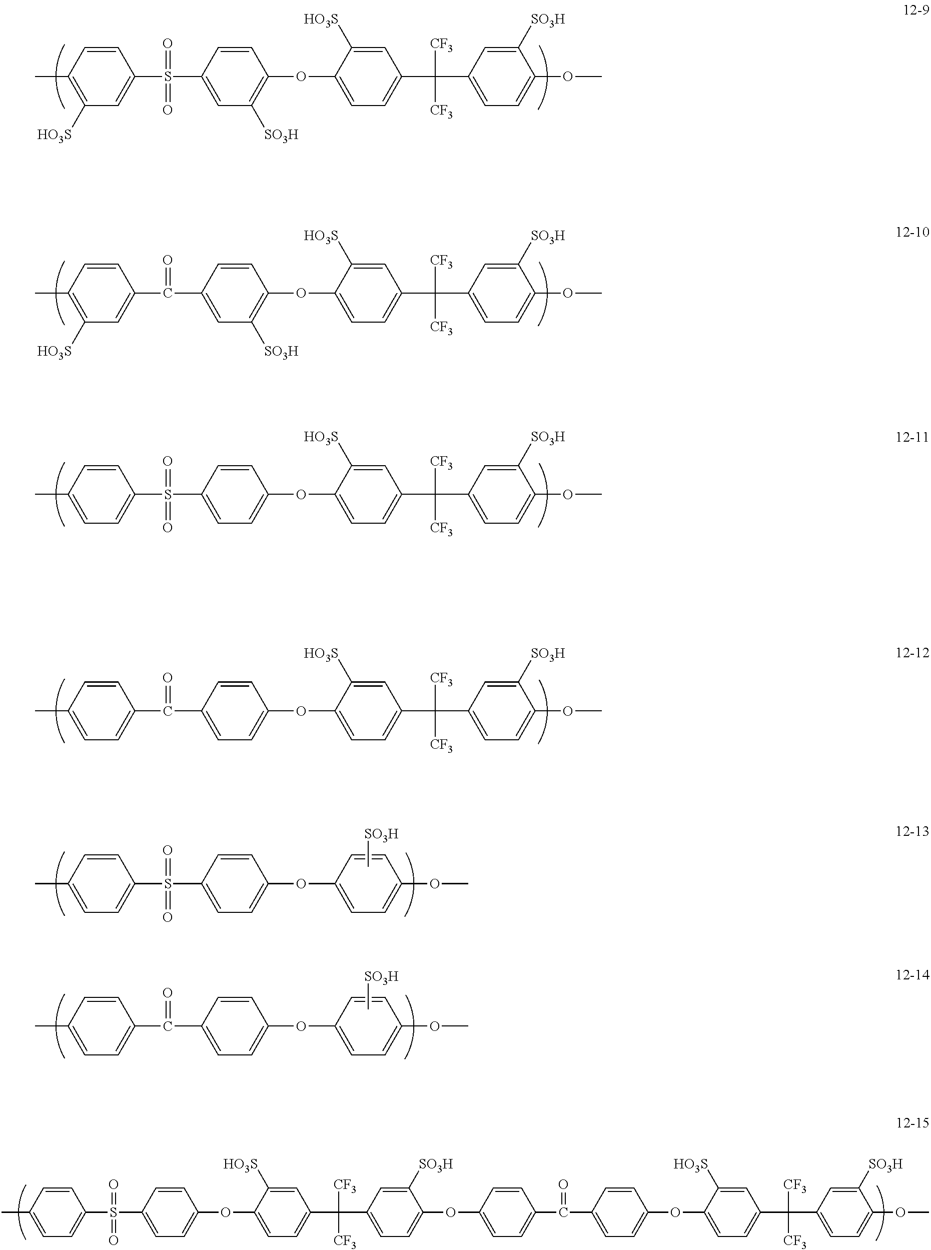

Among those listed above, it is preferable for the polymer electrolyte having the structural unit represented by the above chemical formula (8b) to have the structural unit represented by the following chemical formula (9).

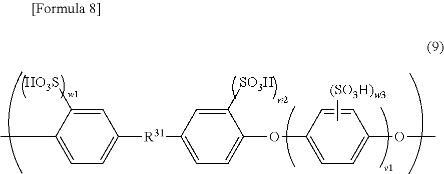

(In this formula, R³¹ represents a carbonyl group or a sulfonyl group; w1 and w2 each independently represents 0 or 1, at least one of them being 1; w3 is 0, 1, or 2; and v1 is 1 or 2.

Examples of structural units wherein a sulfonic acid group has been introduced into the structural unit represented by the above chemical formula (8c) include the structural units represented by the following 13-1 to 13-6.

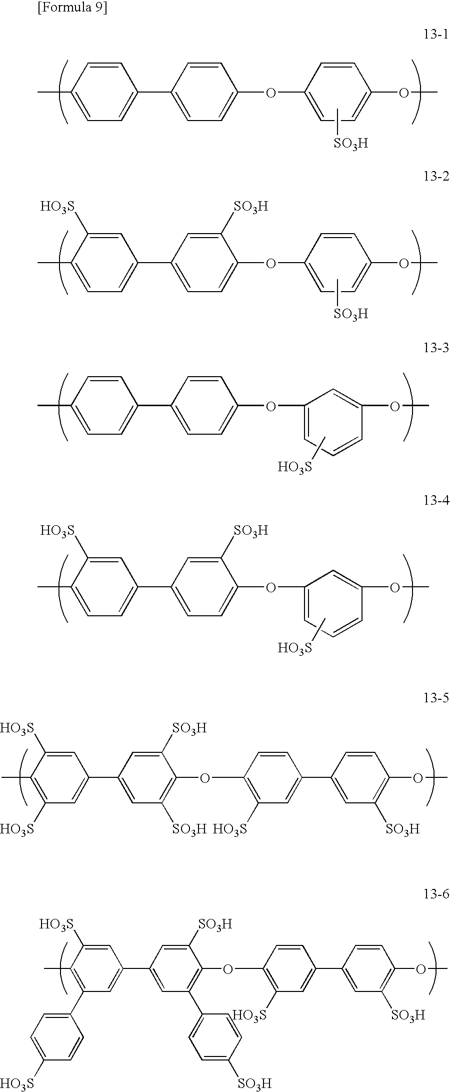

Furthermore, ion-conductive polymers preferred for use in the present invention can contain, apart from the structural unit of the above chemical formula (8), a structural unit having an optionally substituted alkylene group or an optionally substituted fluoroalkylene group. Specific examples include the following structural units:

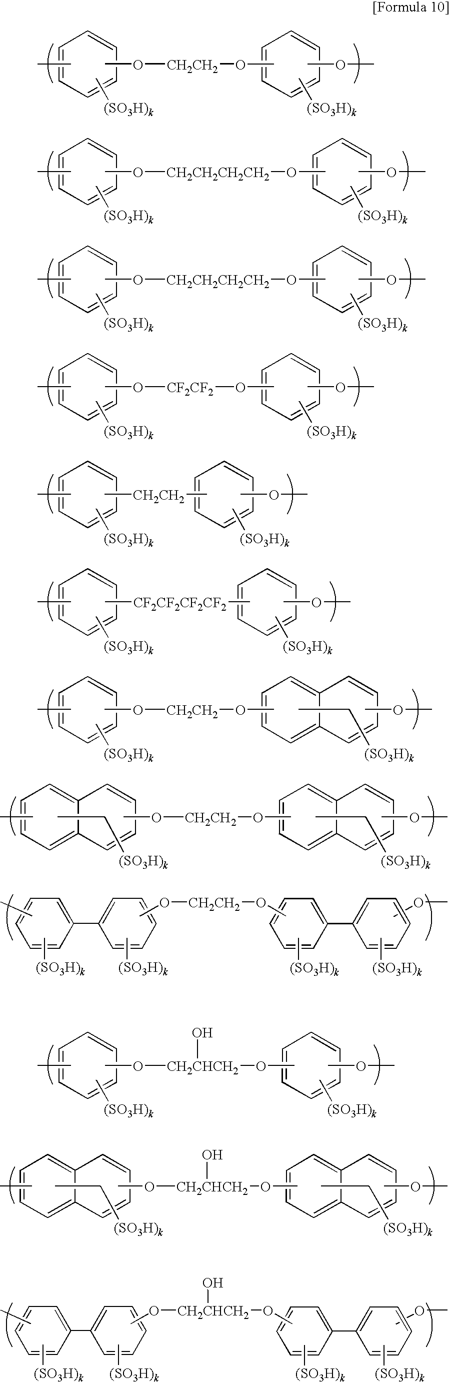

In these formulas, k is 0, 1, or 2, and more than one k in the same structural unit may have the same or different values, provided that there is at least one sulfonic acid group in a structural unit.

The ion-conductive polymer of the present invention can be a polymer compound comprising a structural unit containing a sulfonic acid group as the strongly acidic group, as described above, or it can be a copolymer of such structural units, as described under (E) earlier, and furthermore, it can contain as a copolymer component a structural unit having no ion exchange group associated with proton conduction.

Even for such structural units having no ion exchange group, structural units having an aromatic ring are preferable for the sake of heat resistance, etc. A specific example is a structural unit represented by the following chemical formula (14).

[Formula 11]

Ar⁴¹—R⁴¹ (14)

(In this formula, Ar⁴¹ is a divalent aromatic group optionally substituted with a C1 to C10 alkyl group, a C1 to C10 alkoxy group, a C6 to C10 aryl group, or a C6 to C10 aryloxy group. R⁴¹ represents a direct bond, an oxy group, a thioxy group, a carbonyl group, a sulfinyl group or a sulfonyl group).

Among the structural units represented by chemical formula (14), a structural unit represented by the following chemical formula (15) is preferable.

[Formula 12]

Ar⁵¹—R⁵¹—Ar⁵²-Q⁵¹-Ar⁵³-Q⁵² (15)

(In this formula, Ar⁵¹, Ar⁵², and Ar⁵³ (hereinafter sometimes referred to as “Ar⁵¹ to Ar⁵³”) each independently represents a divalent aromatic group which may optionally have a C1 to C10 alkyl group, a C1 to C10 alkoxy group, a C6 to C10 aryl group, or a C6 to C10 aryloxy group; Q⁵¹ and Q⁵² each independently represents an oxy group or a thioxy group; and R⁵¹ represents a carbonyl group or a sulfonyl group).

In the structural unit represented by the above chemical formula (15), the groups represented by Ar⁵¹ to Ar⁵³ are the same as the groups represented by Ar¹¹ described earlier, the phenylene group being preferable among them. Oxy group (—O—) is preferable as Q⁵¹ and Q⁵². Besides this, in the structural unit represented by the above chemical formula (15), the groups represented by Ar⁵¹ to Ar⁵³, Q″ and Q⁵², or R⁵¹ may be same or different from one structural unit to another.

One of the preferable structural units having no ion exchange group, described above, is a structural unit represented by the following chemical formula (16).

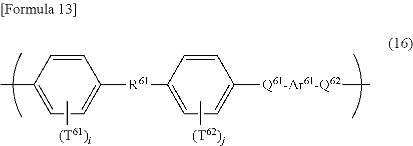

(In this formula, Ar⁶¹ represents a divalent aromatic group which may optionally have a C1 to C10 alkyl group, a C1 to C10 alkoxy group, a C6 to C10 aryl group, or a C6-C10 aryloxy group; Q⁶¹ and Q⁶² each independently represents an oxy group or a thioxy group; T⁶¹ and T⁶² each independently represents a C1 to C10 alkyl group, a C1 to C10 alkoxy group, a C6 to C10 aryl group, or a C6 to C10 aryloxy group; R⁶¹ represents a carbonyl group or a sulfonyl group; and i and j each independently is an integer 0 to 4).

In the above formula, the same groups as listed earlier for Ar⁵³, Q⁵¹, Q⁵², and R⁵¹ are preferable respectively as Ar⁶¹, Q⁶¹, Q⁶², and R⁶¹. Among these, a phenylene group or a biphenylene group is preferable as Ar⁶¹. T⁶¹ and T⁶² may be the same as the earlier-described substituting groups that may optionally substitute Ar²¹ to Ar²⁷. Furthermore, it is particularly preferable that the above-mentioned i and j are zero.

More specifically, examples of the above structural unit having no ion exchange group include those having structural units represented by the following chemical formulas 17-1 to 17-17.

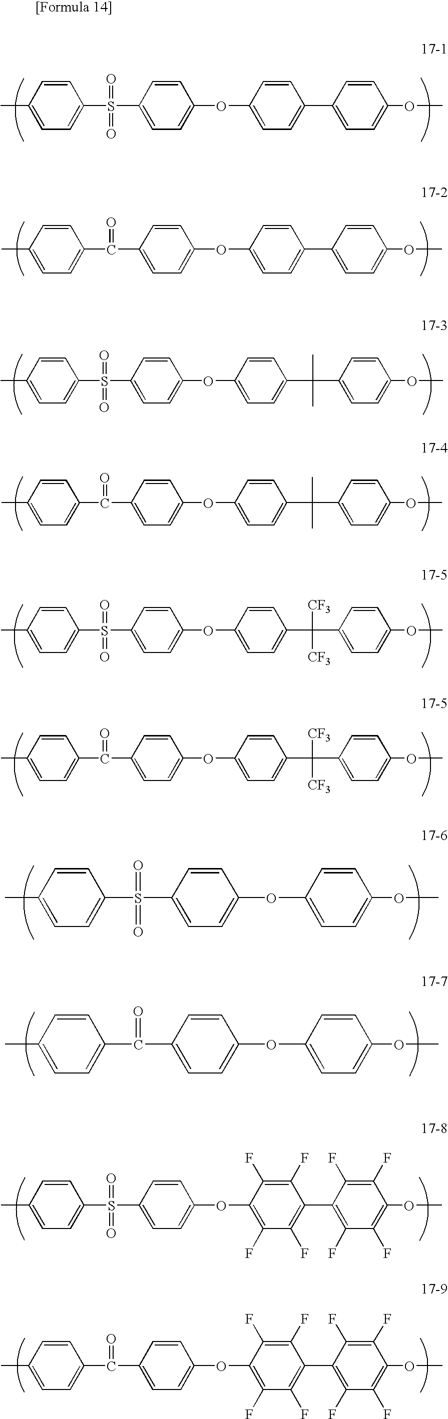

Among these, a structural unit represented by the earlier-described chemical formula (16) is preferable as the structural unit having no ion exchange group, at least one structural unit represented by the above-listed 17-1 to 17-10 and 17-15 to 17-18 being preferable, at least one structural unit represented by 17-1, 17-3, 17-5 to 17-7, and 17-15 to 17-18 being more preferable, and the above-listed 17-1, or 17-15 to 17-18 being particularly preferable.

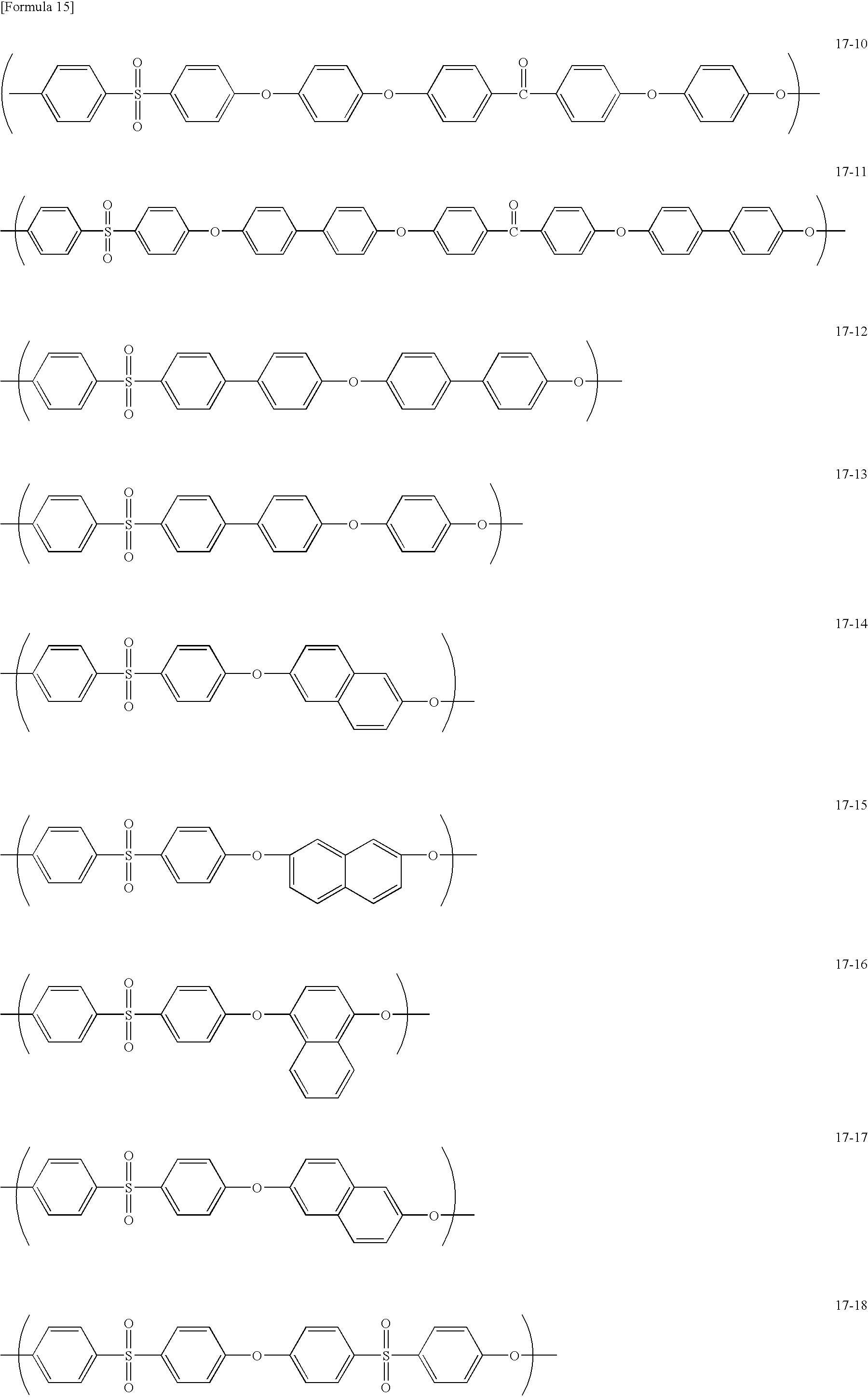

Furthermore, the structural unit having no ion exchange group can contain, in addition to the structural unit represented by the above chemical formula (14), a structural unit having an optionally substituted alkylene group or an optionally substituted fluoroalkylene group. Specific examples include the following structural units:

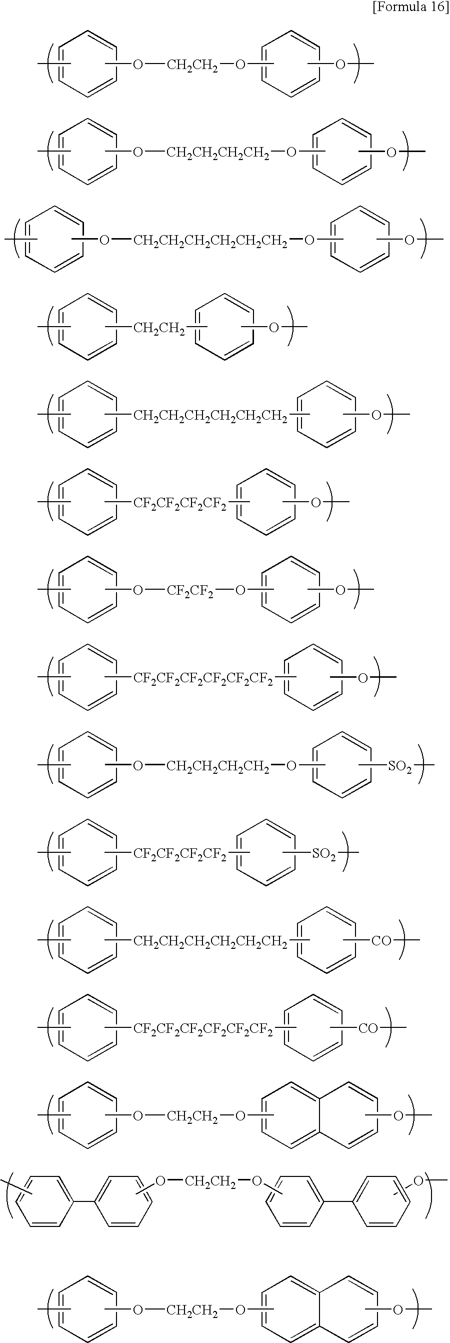

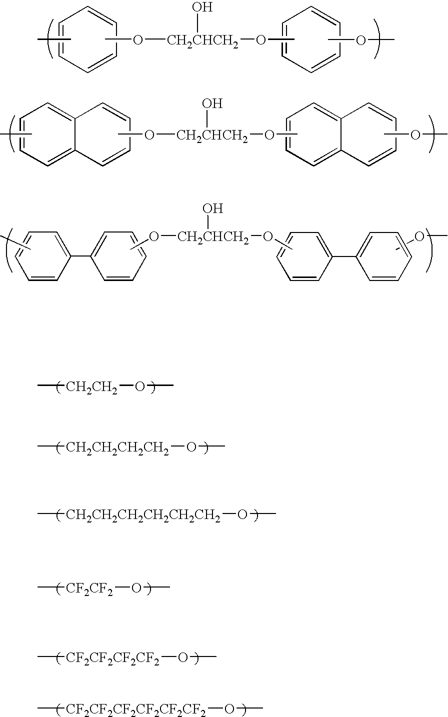

The structural units having an ion exchange group and structural units having no ion exchange group may be forming a random copolymer in the polymer chain, or a graft copolymer with a branched polymer chain.

A preferable ion-conductive polymer is a block copolymer having one or more each of a block comprising structural units wherein a sulfonic acid group is introduced in the above chemical formula (8) (hereinafter referred to as “ion-conductive polymer block”) and a block comprising structural units having substantially no ion exchange group, an example of which is shown as the above chemical formula (14) (hereinafter referred to as “non-ion-conductive polymer block”). Here, an ion-conductive polymer block means a block having 0.5 or more ion exchange groups (preferably sulfonic acid groups) per structural unit constituting the block, and it is more preferable if 1 or more ion exchange groups are present. Non-ion-conductive polymer block here means a block having 0.1 or less ion exchange groups (preferably sulfonic acid groups) per structural unit that constitutes the block, and it is more preferable if there are 0.05 or fewer ion exchange groups.

One of the preferable ion-conductive polymers of this type is, for instance, a polyarylene block copolymer having a block comprising the structural unit represented by the following chemical formula (4) as the ion-conductive polymer block described above.

—Ar¹— (4)

(In this formula, Ar¹ represents a divalent aromatic group that may be optionally substituted with a fluorine atom, a C1 to C10 alkyl group, a C1 to C10 alkoxy group, a C6 to C18 aryl group, a C6 to C18 aryloxy group, or a C2 to C20 acyl group. Ar¹ has at least one ion exchange group in the aromatic ring that constitutes the main chain.

One of the preferable structures for such a block having an ion exchange group is the block represented by the following chemical formula (3).

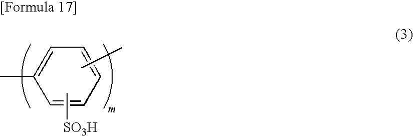

(In this formula, m is an integer 5 or greater).

One of the preferable structures for the non-ion-conductive polymer block is the block represented by the following chemical formula (5).

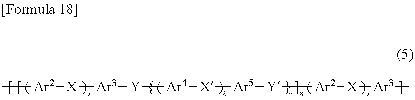

(In this formula, a, b, and c each independently represents 0 or 1 and n represents an integer 5 or greater. Ar², Ar³, Ar⁴, and Ar⁵ each independently represents a divalent aromatic group, and these divalent aromatic groups may optionally be substituted with a C1 to C18 alkyl group, a C1 to C10 alkoxy group, a C6 to C18 aryl group, a C6 to C18 aryloxy group, or a C2 to C20 acyl group. X and X′ each independently represents a direct bond or a divalent group, Y and Y′ each independently represents an oxy group or a thioxy group).

Examples of production methods for such block copolymers include:
I. The method wherein a polymer compound 1 that can form the ion-conductive polymer block and a polymer compound 2 that can form the non-ion-conductive polymer block are produced separately, and then, the polymer compound 1 and polymer compound 2 are coupled.
II. The production method wherein the polymer compound 1 that can form the ion-conductive polymer block is first produced, and this polymer compound 1 and a monomer that can form the non-ion-conductive polymer block are copolymerized.
III. The production method wherein the polymer compound 2 that can form the non-ion-conductive polymer block is first prepared, and this polymer compound 2 and a monomer that can form the ion-conductive polymer block are copolymerized.

Apart from the above-described ion-conductive polymers having acidic groups, those having basic groups can also used as the ion-conductive polymer in the present invention. A known polymer of this type may be suitably selected and used, and examples include polymers having, in the main chain or side chains, a basic group such as a pyrrole ring, a pyrazole ring, an imidazole ring, an oxazole ring, a thiazole ring, a 1,2,3-oxadiazole ring, a 1,2,3-triazole ring, a 1,2,4-triazole ring, a 1,3,4-thiadiazole ring, a pyridine ring, a pyridazine ring, a pyrimidine ring, a pyrazine ring, an indole ring, a benzimidazole ring, a benzoxazole ring, a benzothiazole ring, a purine ring, a quinoline ring, an isoquinoline ring, a 1,2,3,4-tetrahydroquinoline ring, a 1,2,3,4-tetrahydroisoquinoline ring, a cinnorine ring, a quinoxaline ring, a carbazole ring, an acridine ring, a phenothiazine ring, an isoxazole ring, an isothiazole ring, an amino group, etc. Among these, polymers having an imidazole ring, a pyrazole ring, a benzimidazole ring, an amino group, or a pyridine ring, as a basic group, in the main chain or a side chain, are preferable. Even more preferable are polymers having a benzimidazole ring, an amino group, or a pyridine ring as a basic group in the main chain or a side chain. Particularly preferable are polymers having a benzimidazole ring or a pyridine ring as a basic group in the main chain or a side chain, the most preferable being polymers having a benzimidazole ring as a basic group in the main chain or a side chain. These polymers can have any substituting group.

Examples of a polymer having a benzimidazole ring include polybenzimidazole, examples of a polymer having an imidazole ring include poly(vinylimidazole), examples of a polymer having an oxazole ring include poly(vinyloxazole), examples of a polymer having a thiazole ring include poly(vinylthiazole), examples of polymers having a pyridine ring include polypyridine, poly(4-vinylpyridine), and poly(2-vinylpyridine), examples of polymers having an amine include polyethyleneimine and polyvinylamine, examples of a polymer having a pyrrole ring include polypyrrole, and examples of a polymer having a benzoxazole ring include polybenzoxazole.

The ion-conductive composition of the present invention can be produced by mixing the ion-conductive inorganic solid material, examples of which were listed earlier, which is preferably a metal phosphate, with an ion-conductive polymer. Their mixing ratio should preferably be such that the content of the ion-conductive inorganic solid material is more than that of the ion-conductive polymer. In this way, the ionic conductivity in the intermediate and high temperature range can be improved even further. Specifically, it is preferable to keep the content of the ion-conductive inorganic solid material in the range of 66 to 99.9 parts by weight, more preferably 90 to 99.9 parts by weight, for 100 parts by weight of the combined amount of the ion-conductive inorganic solid material and the ion-conductive polymer. The mixing ratio of the ion-conductive inorganic solid material can be suitably optimized, depending on the type of ion-conductive inorganic solid material used, but the range described above is preferable, considering the forming of the composition into a fuel cell part, which will be described later.

When using an above-described type of ion-conductive polymer having a basic group, it is preferable for the ion-conductive composition of the present invention to further contain an acid. A known acid may be selected and used as this acid. Examples of such acids include phosphoric acid, sulfuric acid, methane sulfonic acid, and trifluoromethane sulfonic acid, the preferable acids being phosphoric acid, methane sulfonic acid and trifluoromethane sulfonic acid, phosphoric acid being particularly preferable.

Furthermore, it is preferable for the ion-conductive composition of the present invention to contain at least one fluorine resin. Any known fluorine resin can be appropriately selected and used as such a fluorine resin. Specific examples include polytetrafluoroethylene and copolymers containing the same [tetrafluoroethylene-perfluoroalkyl vinyl ether copolymer, tetrafluoroethylene-hexafluoropropylene copolymer, and tetrafluoroethylene-ethylene copolymer, etc], polyvinylidene fluoride, polychlorotrifluoroethylene, and chlorotrifluoroethylene-ethylene copolymer. Among these, polytetrafluoroethylene and polyvinylidene fluoride are preferable, polytetrafluoroethylene being particularly preferable. More than one fluorine resin can be suitably selected and used. The presence of such a fluorine resin provides the benefit of improved formability when the ion-conductive composition of the present invention is formed into various parts.

Furthermore, the composition can contain an organic silicon compound as an additive. The organic silicon compound can be included in the ion-conductive composite material by adding a monomer (an organic silane compound), which is used as a starting material for the organic silicon compound, to the ion-conductive composition of the present invention. Such a starting material monomer can be suitably selected from known organic silane compounds, and used. Specific examples include vinylsilanes [allyltriethoxysilane, vinyltrimethoxysilane, etc], amino silanes, alkylsilanes [1,8-bis(triethoxysilyl)octane, 1,8-bis(diethoxymethylsil)octane, n-octyltriethoxysilane], and 3-(trihydroxysilyl)-1-propanesulfonic acid]. Preferable among these are alkylsilanes having more than one terminal silyl group, such as 1,8-bis(triethoxysilyl)octane, and 1,8-bis(diethoxymethylsilyl)octane. Also, here, more than one organic silane compound may be suitably selected, and used.

As for the above-described organic silane compound, generally, an organic silane compound at least a part whereof is capable of chemically reacting with the water, etc in the ion-conductive composition of the present invention and convert itself into an organic silicon compound is preferable. The structure of the organic silicon compound is not accurately understood, but generally, its structure is partially determined by the structure of the organic silane compound used. For instance, when a silyl terminal silyl alkane compound such as 1,8-bis(triethoxysilyl)octane is used, from among the compounds listed above as examples, the nonreactive 1,8-bis silyl octane is included as a partial structure in the ion-conductive composite material. By using a terminal silyl alkane compound as the organic silane compound in this manner, the organic silicon compound having the partial structure shown in chemical formula (10) can be included in the ion-conductive composite material.

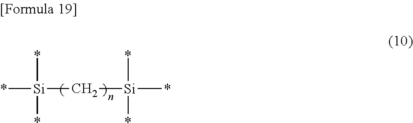

(n represents an integer 4 to 30 both inclusive, the *s indicate bonds).

In this manner, the ion-conductive composition of the present invention can contain various additives, such as the above-described fluorine resins and organic silicon compounds, as long as they do not adversely affect the chemical stability of the composition in the intermediate and high temperature range. Here, however, if the amount of the additive component is more than the metal phosphate or the ion-conductive polymer, this would affect the ion conductivity. Therefore, the preferable total amount of additives is 50 wt. % or less, 30 wt. % or less in particular, of the total amount of ion-conductive composition.

Next, the production method of the ion-conductive composition of the present invention will be described. In the production method, it is necessary to thoroughly mix the ion-conductive inorganic solid material, the ion-conductive polymer, and the additive components added as required. Examples of production methods of the ion-conductive composition include the production method wherein the ion-conductive inorganic solid material is mixed with a solution of the ion-conductive polymer, containing the ion-conductive polymer and an organic solvent, and the mixture is cast, and then dried to evaporate off the solvent; and the production method wherein the ion-conductive inorganic solid material is formed into pellets and the pellets obtained are immersed in an ion-conductive polymer solution comprising an ion-conductive polymer and an organic solvent, and the mixture is dried to evaporate off the solvent.

A preferred method is to prepare all the components in the form of powders, and to mix them thoroughly in a mortar while grinding. When using a metal phosphate, which is a particularly preferred ion-conductive inorganic solid material, it is preferable to keep the metal phosphate in a dehydrated condition. The method of heating in an inert gas such as water vapor-free argon, for instance, may be used for dehydrating the metal phosphate. While mixing the ingredients, a solvent may also be added to prepare a paste suitable for forming. A solvent may be suitably selected from among known organic solvents, and used for this purpose. Specifically, alcohols [methanol, ethanol, n-propanol, etc], alkanes [n-hexane, cyclohexane, etc], aromatic hydrocarbons [benzene, toluene, xylene, etc], ketones [acetone, cyclohexanone, etc], and halogenated hydrocarbons [chloroform, dichloroethane, etc], and the like are preferred.

As for the method of using one of the earlier-described type of ion-conductive polymer having a basic group, and also making it contain phosphoric acid, various methods such as adding the phosphoric acid while mixing the ion conductive inorganic solid material with the ion-conductive polymer solution, can be used. In case the ion-conductive inorganic solid material is a metal phosphate, the use of an excess of phosphoric acid during the production of the metal phosphate, in order to make the metal phosphate contain an excess of phosphoric acid to begin with, is also suitable.

Further, by forming the ion-conductive composition obtained in this manner, ion-conductive membrane, one of the preferred embodiments of the ion-conductive composite material (ion-conductive composition), can be obtained. Any one of the various known methods of forming may be suitably selected and used. Examples of such methods include, casting, blade coating, bar coating, rolling, and roller-rolling. Furthermore, it is preferable to dehumidify the atmosphere to a suitable level during the above-described mixing and forming of the membrane. With the ion-conductive composition of the present invention, a membrane of suitable thickness as an ion-conductive membrane of fuel cells can be obtained by even the simple procedures described as examples above.

Fuel cells can be prepared by using an above-described formed product, preferably an ion-conductive membrane, as the solid electrolyte of the fuel cell. In other words, a fuel cell can be obtained by using an ion-conductive membrane prepared with the ion-conductive composition of the present invention, typically as the solid electrolyte between an anode-cathode pair.

Any known technology can be suitably selected and used for the other constituent parts of the fuel cell, such as the catalyst composition, the fuel supply part, air supply part, etc. However, it is preferable to use the ion-conductive composite material prepared from the ion-conductive composition of the present invention as the electrolyte for the catalyst layer.

Fuel cells prepared in this manner show good power generation performance, the ion-conductive composite material made from the ion-conductive composition of the present invention showing ion conductivity even when the fuel cell is operated in the intermediate and high temperature range where it was very difficult to operate fuel cells having parts made from conventional ion-conductive polymers.

### Examples

The present invention will be described in more detail using some examples. However, the invention is not restricted by these examples.

Measurement of Proton Conductivity (Membrane Thickness Direction)

Impedance in the membrane thickness direction was measured by an alternate current method, by sandwiching the ion-conductive membrane between two platinum foil electrodes. The proton conductivity was measured at different temperatures, i.e., 25° C., 50° C., 80° C., 110° C., 140° C., and 200° C. The measurement was made under a substantially non-humidified condition at each temperature.

Measurement of Proton Conductivity (Membrane Surface Direction)

Impedance in the membrane surface direction was measured by an alternate current method, by sandwiching the ion-conductive membrane between two platinum plate electrodes. In this case, the two platinum plate electrodes were kept parallel with a 1 cm gap. The proton conductivity was measured at different temperatures, i.e., 25° C., 50° C., 80° C., 110° C., and 130° C. in examples 1 to 5, and 120° C., 140° C., 160° C., and 180° C. in examples 6 to 12. In Comparative Example 1, the measurement was made at all these temperatures. The relative humidity was maintained at 90% at the measurement temperatures 25° C., 50° C., or 80° C. whereas the measurements at 110° C. and above were done under a substantially non-humidified condition.

### Preparation Example 1

### Synthesis of Metal Phosphate

7.158 g of SnO₂ (manufactured by Wako Pure Chemical Industries), 0.195 g of Al(OH)₃ (manufactured by Wako Pure Chemical Industries), and 16.141 g of H₃PO₄ (85%, manufactured by Wako Pure Chemical Industries) were placed in a 300 mL beaker, and heated to 300° C. on a hot plate while stirring with a magnetic stirrer. During the heating, 100 mL of deionized water was added, as required, to adjust the viscosity. The entire amount of the viscous paste obtained after 1 hour of heating was placed in an alumina crucible, and heated to 650° C. in an electric furnace, taking 1.5 hours, maintained at that temperature for 2.5 hours, and then cooled to room temperature in 1.5 hours to obtain the metal phosphate. X-ray fluorescence measurements showed that molar ratio of the elements in the metal phosphate obtained was Al_{0.05}Sn_{0.95}P₂O₇. Hereinafter, this metal phosphate will be referred to as “Metal Phosphate 1”.

### Preparation Example 2

### Synthesis of Ion-Conductive Polymer

Following the method described in Example 1 of WO2006-095919, sodium 2,5-dichlorobenzenesulfonate, and chloro-terminal type polyethersulfone (Sumika Excel PES5200P, manufactured by Sumitomo Chemical) were polymerized using bis(1,5-cyclooctadiene)nickel(0) in the presence of 2,2′-bipyridyl, and the polyarylene block copolymer shown below was obtained. (In the formula, n and m represent the degree of polymerization of the respective structural units).

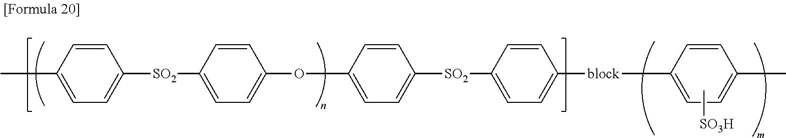

The ion exchange capacity of the polymer obtained was 2.2 meq/g. Hereinafter, this ion-conductive polymer is referred to as “Ion-conductive Polymer 1”.

### Preparation Example 3

### Synthesis of Ion-Conductive Polymer

Following the method described in Example 2 of WO2005-063854, the sulfonated polyarylene ether block copolymer shown below was obtained. (In the formula, n and m represent the degree of polymerization of the respective structural units).

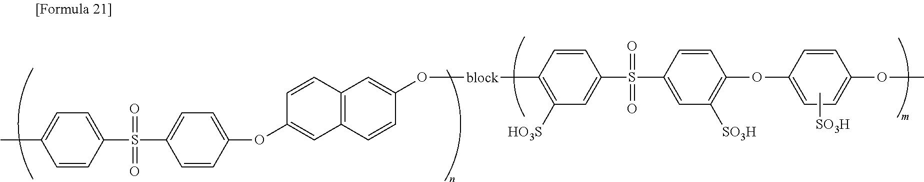

The ion exchange capacity of the polymer obtained was 2.1 meq/g. Hereinafter, this ion-conductive polymer is referred to as “Ion-conductive Polymer 2”.

### Preparation Example 4

### Synthesis of Ion-Conductive Polymer

Following the method described in Example 1 of U.S. Pat. No. 3,313,783, the ion-conductive polymer consisting of the structural units shown below was obtained. This polymer was designated as “ion-conductive Polymer 3”.

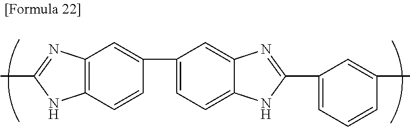

### Example 1

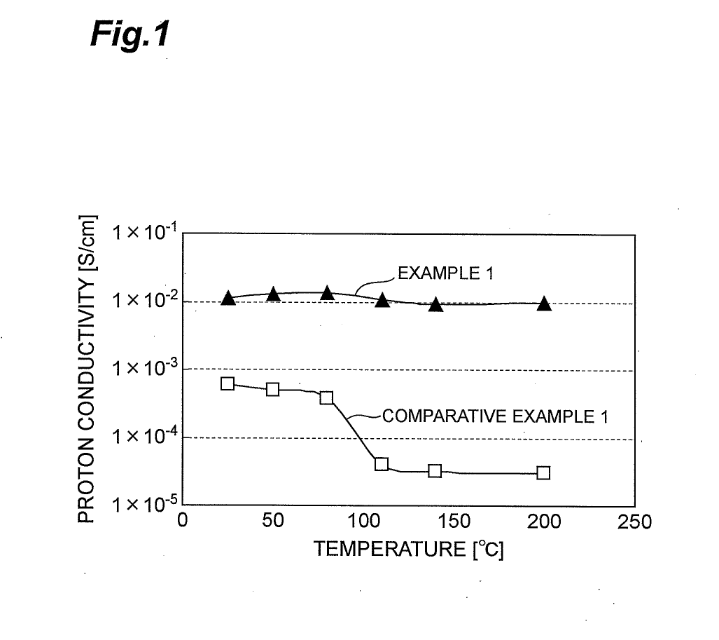

Metal Phosphate 1 (0.450 g), Ion-conductive Polymer 1 (0.050 g), and polytetrafluoroethylene (0.015 g, PTFE30-J, manufactured by DuPont-Mitsui Fluorochemicals Co. Ltd.) were placed in a mortar and mixed until the mixture became clay-like in the mortar. The mixture obtained was rolled to prepare an ion-conductive membrane. The membrane thus obtained had a thickness of 0.120 mm. Proton conductivity (membrane thickness direction) and proton conductivity (membrane surface direction) of this membrane were measured. The results are given in FIG. 1 and Table 1.

### Example 2

Metal Phosphate 1 (0.475 g), Ion-conductive Polymer 1 (0.025 g), and polytetrafluoroethylene (0.015 g, PTFE30-J, manufactured by DuPont-Mitsui Fluorochemicals Co. Ltd.) were placed in a mortar and mixed until the mixture became clay-like in the mortar. The mixture obtained was rolled to prepare an ion-conductive membrane. The membrane thus obtained had the thickness of 0.124 mm. Proton conductivity (membrane surface direction) of this membrane was measured. The results are given in Table 1.

### Example 3

Metal Phosphate 1 (0.485 g), Ion-conductive Polymer 1 (0.015 g), and polytetrafluoroethylene (0.015 g, PTFE30-J, manufactured by DuPont-Mitsui Fluorochemicals Co. Ltd.) were placed in a mortar and mixed until the mixture became clay-like in the mortar. The mixture obtained was rolled to prepare an ion-conductive composite membrane. The membrane thus obtained had the thickness of 0.113 mm. Proton conductivity (membrane surface direction) of this membrane was measured. The results are given in Table 1.

### Example 4

Metal Phosphate 1 (0.490 g), Ion-conductive Polymer 1 (0.010 g), and polytetrafluoroethylene (0.015 g, PTFE30-J, manufactured by DuPont-Mitsui Fluorochemicals Co. Ltd.) were placed in a mortar and mixed until the mixture became clay-like in the mortar. The mixture obtained was rolled to prepare an ion-conductive membrane. The membrane thus obtained had the thickness of 0.135 mm. Proton conductivity (membrane surface direction) of this membrane was measured. The results are given in Table 1.

### Example 5

Metal Phosphate 1 (0.495 g), Ion-conductive Polymer 1 (0.005 g), and polytetrafluoroethylene (0.015 g, PTFE30-J, manufactured by DuPont-Mitsui Fluorochemicals Co. Ltd.) were placed in a mortar and mixed until the mixture became clay-like in the mortar. The mixture obtained was rolled to prepare an ion-conductive membrane. The membrane thus obtained had the thickness of 0.135 mm. Proton conductivity membrane surface direction) of this membrane was measured. The results are given in Table 1.

### Example 6

Metal Phosphate 1 (0.450 g) was placed in a container having 77 g of 5 mm φ zirconia balls, and ground for 3 minutes in a planetary ball mill (model No. 07.301), manufactured by Fritsch, Japan. Ion-conductive Polymer 1 (0.050 g) was added therein and the mixture was ground and mixed for 3 minutes in the same device. Further, polytetrafluoroethylene (0.015 g, PTFE30-J, manufactured by DuPont-Mitsui Fluorochemicals Co. Ltd.) was added therein, and the mixture ground and mixed for 3 minutes in the same device to obtain a clay-like composition. The mixture obtained was rolled to prepare an ion-conductive membrane. The membrane thus obtained had the thickness of 0.192 mm. Proton conductivity (surface direction) of this membrane was measured. The results are given in Table 2.

### Example 7

Metal Phosphate 1 (0.450 g), Ion-conductive Polymer 1 (0.050 g), and polyvinylidene fluoride (0.015 g, manufactured by Aldrich Chemical Co. Inc.) were placed in a mortar and mixed until the mixture became clay-like in the mortar. The mixture obtained was rolled to prepare an ion-conductive membrane. The membrane thus obtained had the thickness of 0.252 mm. Proton conductivity (membrane surface direction) of this membrane was measured. The results are given in Table 2.

### Example 8

Metal Phosphate 1 (0.450 g), Ion-conductive Polymer 2 (0.050 g), and polytetrafluoroethylene (0.015 g, PTFE30-J manufactured by DuPont-Mitsui Fluorochemicals Co. Ltd.) were placed in a mortar and mixed until the mixture became clay-like in the mortar. The mixture obtained was rolled to prepare an ion-conductive membrane. The membrane thus obtained had the thickness of 0.228 mm. Proton conductivity (membrane surface direction) of this membrane was measured. The results are given in Table 2.

### Example 9

Metal Phosphate 1 (0.400 g), a perfluoroalkane sulfonic acid type ion-conductive polymer Nafion (0.100 g, EW=1100, manufactured by DuPont), and polytetrafluoroethylene (0.015 g, PTFE30-J manufactured by DuPont-Mitsui Fluorochemicals Co. Ltd.) were placed in a mortar and mixed until the mixture became clay-like in the mortar. The mixture obtained was rolled to prepare an ion-conductive membrane. The membrane thus obtained had the thickness of 0.308 mm. Proton conductivity (membrane surface direction) of this membrane was measured. The results are given in Table 2.

### Example 10

Metal Phosphate 1 (0.450 g), a perfluoroalkane sulfonic acid type ion-conductive polymer Nafion (0.050 g, EW=1100, manufactured by DuPont), Ion-conductive Polymer 3 (0.010 g), and polytetrafluoroethylene (0.050 g, PTFE30-J manufactured by DuPont-Mitsui Fluorochemicals Co. Ltd.) were placed in a mortar and mixed until the mixture became clay-like in the mortar. The mixture obtained was rolled to prepare an ion-conductive membrane. The membrane thus obtained had the thickness of 0.256 mm. Proton conductivity (membrane surface direction) of this membrane was measured. The results are given in Table 2.

### Example 11

Metal Phosphate 1 (0.450 g), Nafion (0.025 g, EW=1100, manufactured by DuPont), Ion-conductive Polymer 3 (0.001 g), and polytetrafluoroethylene (0.050 g, PTFE30-J manufactured by DuPont-Fluorochemicals Co. Ltd.) were placed in a mortar and mixed until the mixture became clay-like in the mortar. The mixture obtained was rolled to prepare an ion-conductive membrane. The membrane thus obtained had the thickness of 0.203 mm. Proton conductivity (membrane surface direction) of this membrane was measured. The results are given in Table 2.

### Example 12

Metal Phosphate 1 (0.450 g), Ion-conductive Polymer 3 (0.015 g), and polytetrafluoroethylene (0.015 g, PTFE30-J manufactured by DuPont-Mitsui Fluorochemicals Co. Ltd.) were placed in a mortar and mixed until the mixture became clay-like in the mortar. The mixture obtained was rolled to prepare an ion-conductive membrane. The membrane thus obtained had the thickness of 0.203 mm. Proton conductivity (membrane surface direction) of this membrane was measured. The results are given in Table 2.

### Comparative Example 1

Ion-conductive Polymer 1 was dissolved in dimethyl sulfoxide to prepare a 10 wt. % solution of the ion-conductive polymer. The solution obtained was spread on a glass sheet by painting, and the solvent dried off, to obtain an ion-conductive polymer membrane. Proton conductivity (membrane thickness direction) and proton conductivity (membrane surface direction) of this ion conductive polymer membrane were measured. The results are given in FIG. 1 and Table 1.

### Comparative Example 2

Metal Phosphate 1 (0.50 g), and polytetrafluoroethylene (0.015 g, PTFE30-J manufactured by DuPont-Mitsui Fluorochemicals Co. Ltd.) were placed in a mortar and mixed in the mortar. The mixture obtained had poor formability and could not be made into a membrane.

TABLE 1

| | Temperature (° C.) | | | | |
|---|---|---|---|---|---|
| | 25 | 50 | 80 | 110 | 130 |
| | Relative humidity | | | | |
| | | | | Non- | Non- |
| | 90% | 90% | 90% | humidified | humidified |
| Example 1 | 1.8E−01 | 2.3E−01 | 2.8E−01 | 3.7E−02 | 5.8E−02 |
| Example 2 | 1.8E−01 | 2.5E−01 | 3.1E−01 | 7.7E−02 | 1.0E−01 |
| Example 3 | 1.6E−01 | 2.2E−01 | 2.4E−01 | 8.2E−02 | 1.2E−01 |
| Example 4 | 1.9E−01 | 2.6E−01 | 3.2E−01 | 9.4E−02 | 1.2E−01 |
| Example 5 | 1.9E−01 | 2.6E−01 | 2.9E−01 | 9.3E−02 | 1.2E−01 |
| Comparative | 6.8E−02 | 1.1E−01 | 1.5E−01 | Below the | Below the |
| Example 1 | | | | measure- | measure- |
| | | | | ment limit | ment limit |
| | | | | (1.0E−06) | (1.0E−06) |

TABLE 2

| | Temperature (° C.) | | | |
|---|---|---|---|---|
| | 120 | 140 | 160 | 180 |
| Relative | Non- | Non- | Non- | Non- |
| humidity | humidified | humidified | humidified | humidified |
| Example 6 | 2.9E−02 | 3.1E−02 | 3.8E−02 | 3.9E−02 |
| Example 7 | 3.6E−02 | 4.0E−02 | 4.0E−02 | 3.9E−02 |
| Example 8 | 3.9E−02 | 4.5E−02 | 4.7E−02 | 4.9E−02 |
| Example 9 | 9.6E−03 | 1.2E−02 | 9.3E−03 | 8.2E−03 |
| Example 10 | 2.8E−02 | 3.2E−02 | 3.0E−02 | 3.1E−02 |
| Example 11 | 3.9E−02 | 4.1E−02 | 3.4E−02 | 3.1E−02 |
| Example 12 | 5.0E−02 | 5.3E−02 | 4.6E−02 | 3.2E−02 |
| Comparative | Below the | Below the | Below the | Below the |
| Example 1 | measurement | measurement | measurement | measurement |
| | limit | limit | limit | limit |
| | (1.0E−06) | (1.0E−06) | (1.0E−06) | (1.0E−06) |

### Example 13

### Evaluation of Power Generation Performance

A membrane-electrode assembly was prepared using the ion-conductive membrane obtained in Example 2 and the power generation performance was evaluated.

Firstly, 0.83 g of platinum-carrying carbon (SA50BK, manufactured by N.E. Chemcat) carrying 50 wt. % platinum was placed in 6 mL of commercially obtained 5 wt. % Nafion solution (solvent: a mixture of water and a lower alcohol), and 13.2 mL of ethanol was further added therein. The mixture thus obtained was sonicated for 1 hour, and after that, stirred for 5 hours with a stirrer to obtain a catalyst ink.

This catalyst ink obtained was applied on a 2.2 cm² central area of the gas diffusion layer. The distance from the discharge opening to the membrane was kept at 6 cm, and the stage temperature at 75° C. After applying a total of 8 times over the same area, it was left on the stage for 15 minutes to remove the solvent and prepare the membrane as a catalyst layer.

Furthermore, fuel-cell cells were prepared using a commercially obtained Japan Automobile Research Institute (JARI) standard cell. In other words, the gas diffusion layer on which the catalyst ink was applied and a gasket were positioned to sandwich the ion-conductive membrane of Example 2. In this case, the gas diffusion layer was so placed that the surface applied with the ink was in contact with the membrane. Further, the current collectors and end plates were positioned in that order outside this assembly, and fastened with bolts to assemble fuel-cell cells, each with an effective membrane area of 4.84 cm².

The power generation performance at 80° C. of the fuel-cell cells thus obtained was evaluated by supplying non-humidified hydrogen to the anode and non-humidified air to the cathode while maintaining the fuel-cell cells at 80° C. In this case, the gas outlet back pressure of the cell was adjusted at 0.1 MpaG. The hydrogen gas flow rate was 529 mL/minute and the air gas flow rate was 1665 mL/minute. The results of evaluation are given in Table 3.

### Example 14

Furthermore, the power generation performance at 110° C. was evaluated by supplying non-humidified hydrogen to the anode and non-humidified air to the cathode while maintaining the fuel-cell cells at 110° C. In this case, the back pressure at the gas outlet of the cell was adjusted at 0.1 MpaG. The hydrogen gas flow rate was 529 mL/minute and the air gas flow rate was 1665 mL/minute. The results of evaluation are given in Table 3.

TABLE 3

| | Voltage at current density | Voltage at current density |
|---|---|---|
| | 0.1 A/cm | 0.2 A/cm |
| Example 13 | 0.70 V | 0.20 V |
| (80° C.) | | |
| Example 14 | 0.54 | 0.25 V |
| (110° C.) | | |

The ion-conductive composite material (ion-conductive membrane) made from the ion-conductive composition of the present invention shows proton conductivity over a wide temperature range, as is clear from FIG. 1, and it also became clear that fuel cells made using the ion-conductive composite material (ion-conductive membrane) made from the ion-conductive composition of the present invention generate power under high temperature and non-humidified conditions. As fuel cells made using such ion-conductive membrane function over a wide temperature range, they can be used at intermediate and high temperatures above 100° C. after starting, apart from having superior low temperature startability. Therefore, they have advantages like low carbon monoxide poisoning of the catalyst, and the ability to use the exhaust heat effectively. Furthermore, because the ion-conductive membrane made from the ion-conductive composition of the present invention has good formability, it can have large area, and moreover, as the fuel cells that use the ion-conductive composite membrane of the present invention can be stacked, high output can be obtained.

### Example 15

Metal Phosphate 1, poly(4-vinylpyridine) and polytetrafluoroethylene (PTFE30-J manufactured by DuPont-Mitsui Fluorochemicals Co. Ltd.) were placed in a mortar and mixed until the mixture became clay-like in the mortar. The mixture obtained was rolled to prepare an ion-conductive membrane. The membrane thus obtained have proton conductivity at 100° C. and higher temperature under substantially non-humidified conditions (shortened as “under non-humidified conditions” in the following examples).

### Examples 16 to 20

The procedure was carried as in examples 1 to 5, except for using polyvinylpyrrolidone in place of Ion-conductive Polymer 1. Compositions having high proton conductivity even under non-humidified conditions are obtained.

### Examples 21 to 25

The procedure was carried as in examples 1 to 5, except for using polethyleneimine in place of Ion-conductive Polymer 1. Compositions having high proton conductivity even under non-humidified conditions are obtained.

### Examples 26 to 30

The procedure was carried as in examples 1 to 5, except for using polyvinylamine in place of Ion-conductive Polymer 1. Compositions having high proton conductivity even under non-humidified conditions are obtained.

### Examples 31 to 35

The procedure was carried as in examples 1 to 5, except for using polypyrrole in place of Ion-conductive Polymer 1. Compositions having high proton conductivity even under non-humidified conditions are obtained.

### Examples 36 to 40

The procedure was carried as in examples 1 to 5, except for using polypyridine in place of Ion-conductive Polymer 1. Compositions having high proton conductivity even under non-humidified conditions are obtained.

### Examples 41 to 45

The procedure was carried as in examples 1 to 5, except for using polybenzoxazole in place of Ion-conductive Polymer 1. Compositions having high proton conductivity even under non-humidified conditions are obtained.

1. An ion-conductive composition characterized by comprising an ion-conductive polymer and an ion-conductive inorganic solid material.

2. The ion-conductive composition according to claim 1, wherein the content by weight of the ion-conductive inorganic solid material is higher than the content by weight of the ion-conductive polymer.

3. The ion-conductive composition according to claim 1, wherein the ion-conductive inorganic solid material is a metal phosphate.

4. The ion-conductive composition according to claim 3, wherein the metal phosphate is a phosphate having as the metal element one or more metal elements M selected from the group of elements in Group 4A and Group 4B of the long form of the periodic table, and that M is partially substituted with a doping element J (wherein J is one or more elements selected from the group of elements in Group 3A and Group 3B of the long form of the periodic table).

5. The ion-conductive composition according to claim 4, wherein the phosphate having the metal element M is a phosphate substantially represented by the following chemical formula (1):
MP₂O₇ (1)
(wherein M represents an element selected from the group of elements in Group 4A and Group 4B of the long form of the periodic table).

6. The ion-conductive composition according to claim 4, wherein the metal phosphate is a metal phosphate that is substantially represented by the following chemical formula (2):
M₁₋ₓHₓP₂O₇ (2)
(wherein the value of x is in the range 0.001 to 0.3 both inclusive, and M and J have the same meaning as described above).

7. The ion-conductive composition according to claim 4, wherein the metal phosphate comprises one or more elements selected from the group consisting of In, B, Al, Ga, Sc, Yb, and Y, as the doping element J.

8. The ion-conductive composition according to claim 4, wherein the metal phosphate comprises Al as a doping element J.

9. The ion-conductive composition according to claim 4, wherein the metal phosphate is a metal phosphate where the doping element J is Al.

10. The ion-conductive composition according to claim 4, wherein the metal element M of the metal phosphate is one or more selected from the group consisting of Sn, Ti, Si, Ge, Pb, Zr, and Hf.

11. The ion-conductive composition according to claim 4, wherein the metal element M of the metal phosphate is Sn.

12. The ion-conductive composition according to claim 1, wherein the composition is prepared by grinding and mixing a powder form of the ion-conductive polymer and a powder form of the ion-conductive inorganic solid material.

13. The ion-conductive composition according to claim 1, wherein the composition further comprises a fluorine resin.

14. The ion-conductive composition according to claim 13, wherein the fluorine resin is polytetrafluoroethylene.

15. The ion-conductive composition according to claim 13, wherein the fluorine resin is polyvinylidene fluoride.

16. The ion-conductive composition according to claim 1, wherein the glass transition point temperature of the ion-conductive polymer is 90° C. or higher.

17. The ion-conductive composition according to claim 1, wherein the ion-conductive polymer has an aromatic ring in the main chain thereof.

18. The ion-conductive composition according to claim 1, wherein the ion-conductive polymer is a block copolymer having both a block having an ion exchange group and a block having substantially no ion exchange group.

19. The ion-conductive composition according to claim 18, wherein the ion-conductive polymer is a block copolymer containing a block represented by the following chemical formula (3), as the block having an ion exchange group: 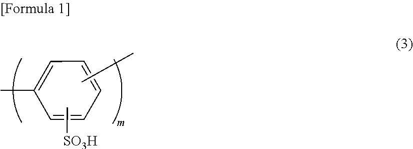
(wherein m is an integer 5 or more).

20. The ion-conductive composition according to claim 18, wherein the ion exchange group in the ion-conductive polymer is a basic ion exchange group.

21. The ion-conductive composition according to claim 20, wherein the ion exchange group in the ion-conductive polymer is a nitrogen atom-containing basic ion exchange group.

22. The ion-conductive composition according to claim 20, wherein the composition comprises a metal phosphate as the ion-conductive inorganic solid material, and further comprises phosphoric acid.

23. An ion-conductive membrane, characterized in that the membrane is prepared from an ion-conductive composition according to claim 1.

24. An electrode catalyst composition characterized by comprising an ion-conductive composition according to claim 1 and a catalyst material.

25. A membrane-electrode assembly comprising an ion-conductive membrane according to claim 23, and/or a catalyst layer prepared from an electrode catalyst composition according to claim 24.

26. A fuel cell characterized by comprising a membrane-electrode assembly according to claim 25.
